(19) United States
(12) Patent Application Publication
(10) Pub. No.: US 2005/0102210 A1
(43) Pub. Date: May 12, 2005

(54) United crimes elimination network

(76) Inventors: Yuh-Shen Song, Northridge, CA (US); Catherine Lew, Northridge, CA (US); Alexander Song, Northridge, CA (US); Victoria Song, Northridge, CA (US)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/860,359

(22) Filed: Jun. 2, 2004

Related U.S. Application Data
(60) Provisional application No. 60/507,671, filed on Oct. 2, 2003.
(60) Provisional application No. 60/572,428, filed on May 20, 2004.

(51) Int. Cl. G06F 17/60

(52) U.S. Cl. 705/35; 705/42

(57) ABSTRACT

A computerized United Crimes Elimination Network (“UCEN”) utilizes the infrastructure established by the Bank Secrecy Act and the permission granted by the USA PATRIOT Act to coordinate efforts by government agencies, financial institutions, merchants, and other entities to jointly detect, monitor, and investigate suspicious activities for the purpose of anti-terrorism, anti-money laundering, and crime elimination.

This application claims priority of U.S. provisional patent application No. 60/507,671 filed on Oct. 2, 2003, and U.S. provisional patent application filed May 20, 2004, number unknown at this time, which are hereby incorporated by reference into this application.

### FIELD OF INVENTION

The present invention relates generally to computerized financial networks. More specifically, the present invention uses a computerized financial network to enable government agencies, financial institutions, merchants, and/or other entities to cooperate in combating terrorism, money laundering, drug dealing, fraud, identity theft, and/or other criminal activity involving banks and other financial institutions.

### BACKGROUND OF THE INVENTION

The Bank Secrecy Act (31 C.F.R. 103) has been in effect since 1970 and places an obligation on financial institutions to report suspicious activities to the responsible government agency (currently “Financial Crimes Enforcement Network” or “FinCEN”) within a certain period of time.

On Oct. 26, 2001, President George W. Bush signed the USA PATRIOT Act (Public Law No. 107-56), which substantially amends Title 31, Chapter 53 of the United States Code. This new bill increases penalties on financial institutions for violations of the Bank Secrecy Act. In addition to placing severe monetary penalties, government regulators have also issued a substantial number of Cease and Desist Orders (C&Ds”), Memoranda of Understanding (“MOUs”), or Written Agreements (“WAs”) to financial institutions for violations of the Bank Secrecy Act. As a result, financial institutions are obliged to spend a tremendous amount of resources to monitor, detect, investigate, and report suspicious activities, using the Suspicious Activity Report (“SAR”) format required by the Bank Secrecy Act.

At this time, FinCEN is receiving more than one million SARs every year. The number of SARs is increasing rapidly because more and more financial institutions are using modern computer technology to facilitate the detection of suspicious activities and the filing of SARs.

FinCEN (or any other single government agency) has only limited resources to investigate these millions of suspicious cases. It is often too late when FinCEN positively identifies a crime after a lengthy investigation. Although the criminals may be eventually punished, the damage may have already been done. It is much more desirable to take preventive actions in advance rather than to punish the perpetrators after damage has already been done.

Very often, financial crimes are committed using multiple financial institutions and cannot be detected by any single financial institution until it is too late. Section 314 (a) of the USA PATRIOT Act permits cooperation between government agencies and financial institutions for the purpose of anti-terrorism and anti-money laundering.

Section 314 (b) of the USA PATRIOT Act permits financial institutions to jointly investigate suspicious activities for the purpose of anti-terrorism and anti-money laundering provided the financial institutions have filed reports with the Treasury Department, indicating their intentions for a joint investigation.

Although the purpose is limited for anti-terrorism and anti-money laundering as stated in the Section 314, the scope of detection and investigation has become extremely broad. According to recent reports complied by FinCEN, a commercial coupon fraud was in fact a terrorist financing activity. In reality, any financial crime can eventually turn out to be a terrorist financing activity and the anti-terrorism efforts of financial institutions cannot overlook any suspicious transactions or activities.

Presently, some security officers of financial institutions in a local area have commenced to communicate with each other to check whether they have a common suspect involved in the suspicious activities, which their financial institutions have detected. To date, this kind of cooperation has been very limited.

With today's technology, a financial crime can be committed using, for example, a bank in Los Angeles, a credit union in New York, and a brokerage firm in Houston. The chance for the security officer of the bank in Los Angeles to communicate with the security officer of the credit union in New York and the security officer of the brokerage firm in Houston for the purpose of discussing a suspect is practically zero. Most likely, they would have no idea that they had a common suspect, who might be committing related crimes.

There are more than 50,000 financial institutions in the USA today. The probability for the correct parties to participate in a joint investigation is less than 1 divided by 2 to the power of 50,000.

Certain relevant terminology is defined in the appended Table.

| | |
|---|---|
| “network” or “networks” | Communication network or networks, wireless |
| | or wired, private or public, or a combination of |
| | them, and includes the well-known Internet. |
| “computer system” | One computer or a cluster of computers, which |
| | stores data and runs applications |
| “bank” or “financial | Either a bank or a non-bank, which provides |
| institution” | financial services |
| “suspect” | Person or organization associated with detected |
| | suspicious activities |
| “security officer” or | Authorized person (or persons) of a financial |
| “risk manager” | institution, who is (or are) responsible for the |
| | monitoring, detection, investigation, and |
| | reporting of suspicious activities |
| “entities” | Participating organizations or legal entities |
| | which participate in the United Crimes |
| | Elimination Network (UCEN). |
| “reporting entities” | Entities which have reported a specific suspect |

### SUMMARY OF THE INVENTION

There is provided a system that can precisely facilitate the joint investigation among all financial institutions and government agencies in order to fully benefit from the Section 314(a) and the Section 314(b) of the USA PATRIOT Act to detect and eliminate financial crimes.

As a result, not only the government agencies can better combat terrorism, money laundering or other crimes to further enhance national security, but financial institutions, merchants, and other entities can also eliminate a substantial amount of losses and damages caused by fraud and other crimes.

One objective of a presently preferred embodiment of the present invention is to provide early warnings to any involved government agencies, financial institutions, merchants, and/or other entities when a possible suspect is identified. Another objective of that embodiment is to facilitate joint monitoring and investigation among government agencies, financial institutions, merchants, and/or other entities about suspects and suspicious activities to eliminate crimes.

In that preferred embodiment, a computerized system hereinafter referred to as a United Crimes Elimination Network (“UCEN”) is established to collect information about suspects and suspicious activities reported by government agencies, financial institutions, merchants, and other entities. To fully utilize the existing infrastructure of the financial industry, the UCEN computer system may communicate with the computer systems which are used by financial institutions to detect suspicious activities such as money laundering, identity theft, check kiting, check fraud, credit/debit card fraud, loan fraud, counterfeit check, counterfeit credit/debit card, counterfeit instrument, false statement, wire transfer fraud, etc. All of the collected information about those suspects and suspicious activities may be stored in a UCEN database,

In one embodiment, the UCEN computer system compares the identities of the suspects of all reported cases with the identity of a suspect reported in a new case. Once a match is found, the UCEN computer system immediately informs the reporting entities, which have the common suspects, so that they can start their joint investigation of the suspects and suspicious activities. To meet certain government requirements, which require financial institutions to file a report with the government agencies before sharing the information, the UCEN may also facilitate the filings of these reports.

In another embodiment, an authorized person from a designated government agency, financial institution, or other entity, may also log into the UCEN computer system to inquire whether a specific person has ever been identified as a suspect by other entities. If a match is found, the contact information of those reporting entities which reported the suspect, and/or the case description or other case identification information, are made available for further action.

In an alternative embodiment, UCEN uses certain criteria to provide a filtered list of suspects, which can be compared against all the customers of a financial institution. Once a match is found, the contact information of the reporting entities which reported the suspects, and/or the case description (or other case identification information) will be available from UCEN for further action.

The case description or other case identification information provided by UCEN may include the category of the suspicious activity, transaction types, location of the activity, dollar amount involved, the name of the financial institution, time of the event, brief description, etc. and is preferably subject to any agreed commercial arrangements and to any applicable legal constrains.

### BRIEF DESCRIPTION OF THE FIGURES

FIG. 1 is an exemplary system diagram with four users (or, reporting entities) connected to the United Crimes Elimination Network (UCEN).

FIG. 2 is an exemplary flow chart showing how an entity can log into the UCEN computer system, search for a suspect, and obtain information to perform a joint investigation of suspicious activities of this suspect, using the UCEN computer system shown in FIG. 1.

FIG. 3 is an exemplary flow chart showing how an entity can obtain a list of suspects and the entity can then use that list to screen its existing database (e.g. customer database), using the UCEN computer system shown in FIG. 1.

FIG. 4 is an exemplary flow chart showing how an entity can input a list of individuals and organizations, and request UCEN to check whether there are any matches in the UCEN database, using the UCEN computer system shown in FIG. 1.

FIG. 5 is an exemplary screen layout of the UCEN system to collect information about an individual.

FIG. 6 is an exemplary screen layout of the UCEN system to collect information about an organization.

FIG. 7 is an exemplary screen layout of the UCEN system to collect information about the category of the case.

FIG. 8 is an exemplary screen layout of the UCEN system to collect information about the dollar amount, location, and time frame of the case.

### DETAILED DESCRIPTION OF CERTAIN PREFERRED EMBODIMENTS AND COMBINATIONS OF EMBODIMENTS

The present invention potentially includes a number of embodiments to provide maximum flexibility in order to satisfy many different needs of both sophisticated and unsophisticated users. Accordingly, we will describe in detail only a few examples of certain preferred embodiments of the present invention and combinations of those embodiments.

During the data collection process, in one embodiment of the present invention, an authorized person (e.g., security officer) of a financial institution can log into the UCEN computer system and manually enter the information about a suspicious activity and the identity of the suspect.

In another embodiment of the present invention, an authorized person (e.g., security officer) of a financial institution can log into the UCEN computer system and upload the electronic data files of suspects and suspicious activities, which the financial institutions can produce through their existing systems.

In yet another embodiment of the present invention, the computer system, which may be used by the financial institution to monitor, detect, investigate, or report suspicious activities will automatically upload data of suspects and suspicious activities to the UCEN computer system.

Since the government requires financial institutions to report to the government their intention to jointly investigate a specific case before sharing the information, in one embodiment of the present invention, the UCEN computer system can request the reporting entities to certify that that they have filed such a report before sharing the information.

In another embodiment of the present invention, the UCEN computer system can further file the reports with the appropriate government agencies after completing the reports for financial institutions, declaring their intention to share the information.

In an alternative embodiment of the present invention, an authorized government agency can also input to the UCEN computer system the information of suspicious cases and the identities of the suspects based on manual entry or upload of electronic files. The contact information of the government agency may be recorded in the UCEN database for future contact purposes.

In another alternative embodiment of the present invention, authorized personnel of a merchant or other entities can log into the UCEN computer system to report any suspicious activity and the identity of the suspect.

A different level of creditability may be assigned to different information sources. For example, the information input by government agencies may be given the highest level of creditability. The information input by financial institutions may be given the regular level of creditability. The information input by merchants may be given a lower level of creditability because merchants are less regulated by the government for information accuracy, while the financial institutions are more regulated.

Once the information is collected into the UCEN database, the UCEN computer system can use these pieces of information of different creditability levels for many different purposes using a variety of different applications.

A different level of accessibility may be assigned to different users of the UCEN computer system. For example, merchants may not be permitted to access the information reported by financial institutions, because the government may only permit financial institutions to share information among themselves, not with merchants.

The control of creditability and accessibility may be adjusted by UCEN from time to time base on the practicality of the situation and the requirements by law.

In one embodiment of the present invention, authorized personnel of a government agency, a financial institution, a merchant, or other entities can log into the UCEN computer system to check whether a specific individual or organization has ever been identified as a suspect by any other entities. If a match is found in the UCEN database, the information about the suspicious case and the contact information of the reporting entities may be provided by the UCEN computer system, depending on the access right. A message (e.g., e-mail, fax, phone, etc.) may be sent to the reporting entities, which have reported this common suspect, so that they can jointly investigate the suspect and the suspicious activities.

In another embodiment of the present invention, a computer system of the financial institution automatically uploads a list of entities (e.g., existing or new customers) to the UCEN computer system, and asks UCEN to compare the list against its database. If a match is found, the UCEN computer system automatically informs the computer system of the financial institutions the case description and contact information of the reporting entities so that a joint investigation can be conducted

In an alternative embodiment of the present invention, the UCEN computer system provides financial institutions, based on their criteria, with a list of all the suspects, whom were reported by various reporting entities. A financial institution can manually compare the suspects on this list with its own customer database. If there are any matches, a financial institution can manually request the UCEN computer system to provide more information about the reporting entities, matching suspects, and/or case descriptions to facilitate the joint investigation.

In another alternative embodiment of the present invention, a computer system of the financial institution automatically downloads the list of suspects based on certain criteria from the UCEN computer system, and compares the list against its customer database. If a match is found, the computer system automatically obtains from the UCEN computer system the case description and contact information of the reporting entities so that a joint investigation can be conducted.

In yet another embodiment of the present invention, the UCEN computer system informs all participating entities of a confirmed crime such as counterfeit identification card, counterfeit check, etc. so that these entities can take proper preventive steps to protect themselves.

Government agencies can use the UCEN facilities to establish a variety of mechanism to combat terrorism, money laundering, drug dealing, and other crimes.

In one embodiment of the present invention, an authorized government agency can log into the UCEN computer system and request for information of any suspicious cases about a specific suspect. The contact information of the reporting entities and case description will be available for a joint investigation.

In another embodiment of the present invention, an authorized government agency can request the UCEN computer system, based on certain criteria, to provide a list of all suspects. This list can be used by the government agency for various purposes.

In an alternative embodiment of the present invention, an authorized government agency can use a computer system to automatically communicate with the UCEN computer system for various purposes.

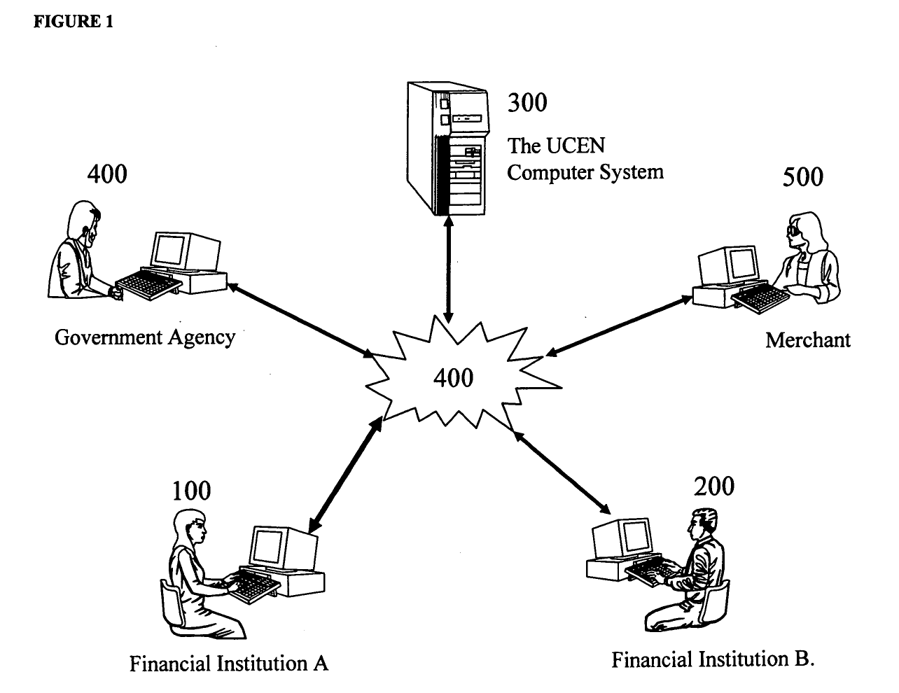

As contemplated in certain described embodiments, four types of entities may use the UCEN computer system 300 as shown in FIG. 1.

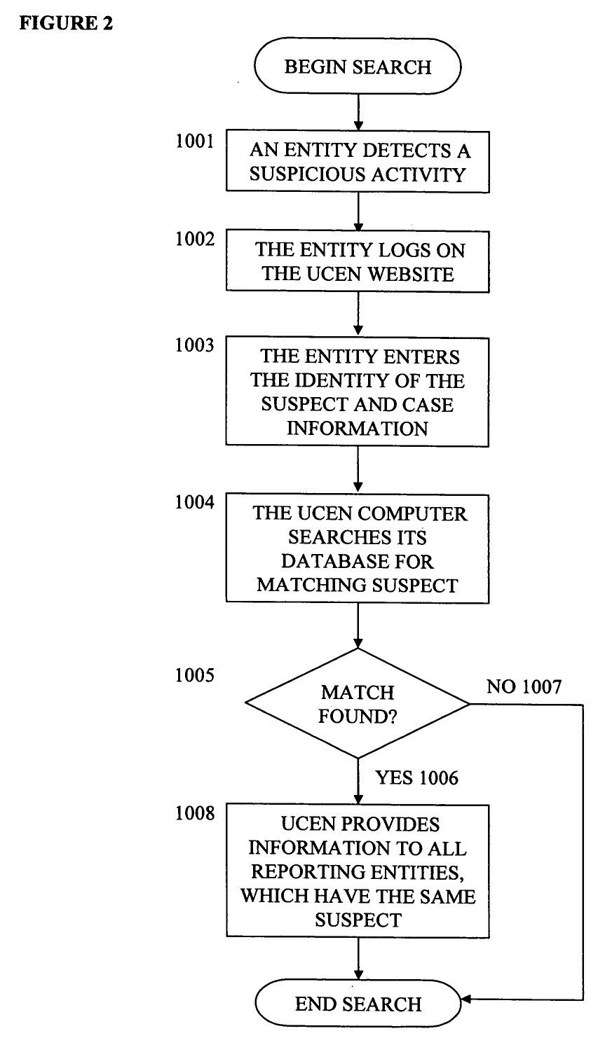

References should now be made to the flowchart of FIG. 2 in combination with the system diagram of FIG. 1, which together illustrate how Reporting Financial Institution A 100 uses the UCEN computer system 300 to search for a suspect, relating to whom Reporting Financial Institution A 100 has detected suspicious activities (block 1001).

Then (block 1002), Reporting Financial Institution A 100 logs into the UCEN computer system 300 via network 400.

Reporting Financial Institution A 100 enters the identity of the suspect and the case description into the UCEN computer system 300 (block 1003). The case description may include the category, the dollar amount, location, and time frame of the suspicious activities.

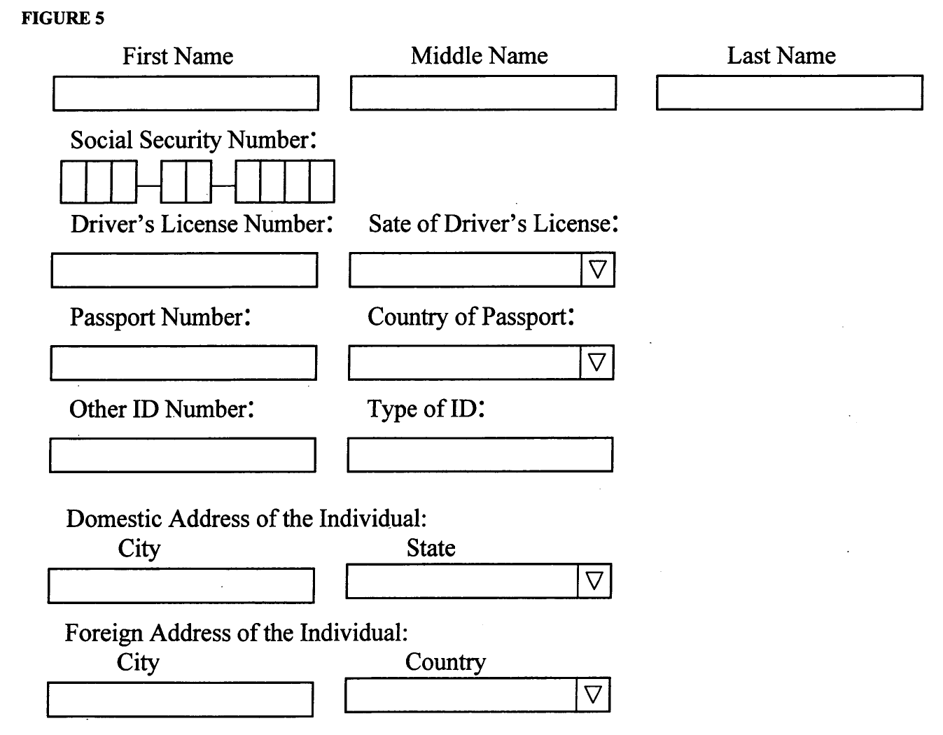

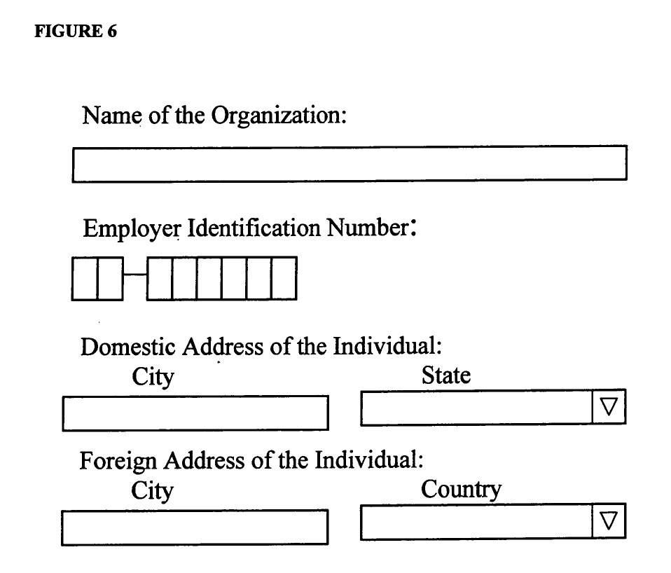

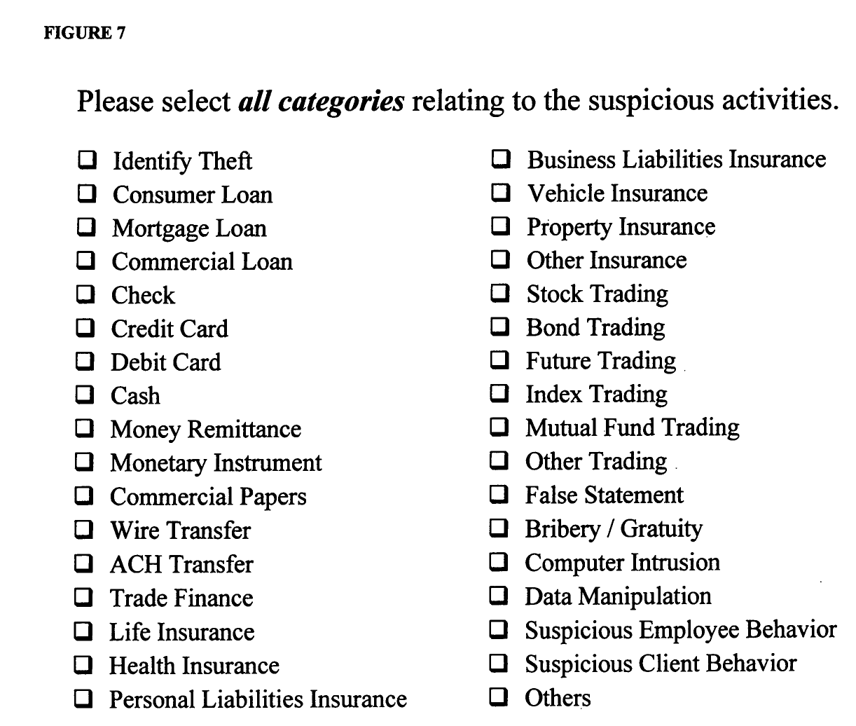

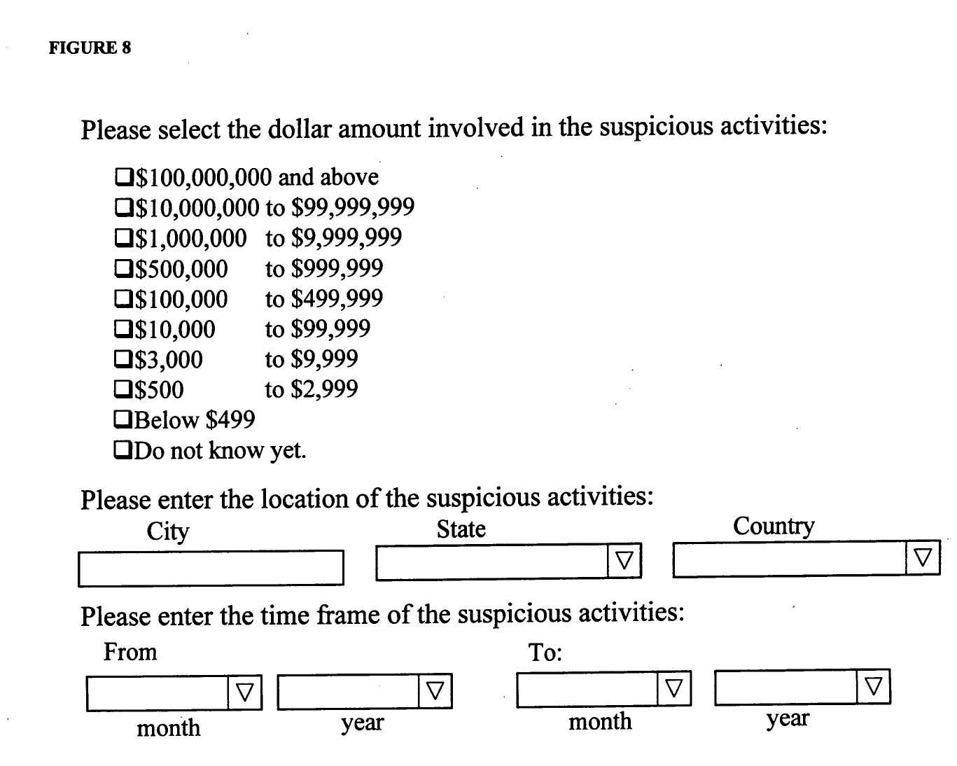

FIG. 5 is an exemplary screen layout for collecting information about an individual. FIG. 6 is an exemplary screen layout for collecting information about an organization. FIG. 7 is an exemplary screen layout for collecting information about the categories of the suspicious activities. FIG. 8 is an exemplary screen layout for collecting information about the dollar mount, location, and time frame of the suspicious activity.

The UCEN computer system 300 searches its database to identify whether there is any existing case that has a matching suspect (block 1004).

After the search, the UCEN computer system 300 determines whether there is any match (decision block 1005). If a match is found (“YES” branch 1006 from decision block 1005), the UCEN computer system 300 informs Reporting Financial Institution A 100 of other reporting entities that have the same suspect (block 1008).

In general, two individual suspects are classified as “matched” if they have the same identification number (e.g., driver license number, or passport number). It is common for two individuals to have an identical name, and therefore, it is not a match if two individuals have only the same name. However, two different names with the same ID number often imply a case of fraud.

Two organization suspects are classified as “matched” if they have the same employer identification number. However, if the employer identification number is not available, two organizations having the same name in the same city are also considered matched.

If Reporting Financial Institution B 200 has reported the same suspect before, the UCEN computer system 300 will also inform Reporting Financial Institution B 200 of the matching suspect and the contact information of Reporting Financial Institution A 100 via e-mail, fax, or other media, so that Reporting Financial Institution A 100 and Reporting Financial Institution B 200 can contact each other for a joint investigation.

On the other hand, if a match is not found (“NO” branch 1007 from the decision block 1005), no action may be necessary. The UCEN computer 300 system may then keep the information entered by Reporting Financial Institution A 100 for future reference.

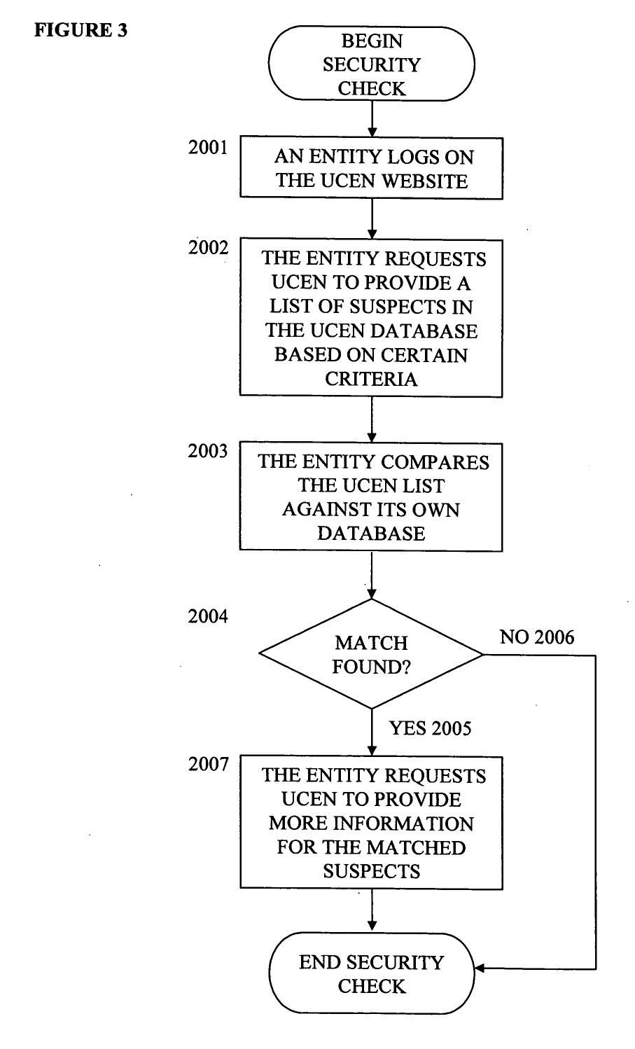

References should also be made to the flowchart of FIG. 3 in combination with the system diagram of FIG. 1, which together illustrate how Reporting Financial Institution A 100 uses the UCEN computer system 300 to check whether it has any customer, who is also a suspect in the UCEN database.

First (block 2001), Reporting Financial Institution A 100 logs into the UCEN computer system 300 via network 400.

Then (block 2002), Reporting Financial Institution A 100 requests the UCEN computer system 300 to provide a list of suspects based on certain criteria.

For example, the criteria can be “Please list all the suspects in the mortgage loan category for suspicious activities occurred in the State of Texas with dollar amount above $500,000 during July 2001 to May 2004.”

After receiving the list (block 2003), Reporting Financial Institution A 100 compares its customer database against this list provided by the UCEN computer system 300.

Reporting Financial Institution A 100 will take two different actions based on whether there is any match between the list and the customer database (decision block 2004).

If there is no match (“NO” branch 2006 from the decision block 2004), the security check is complete.

If there is a match (“YES” branch 2005 from the decision block 2004), Reporting Financial Institution A 100 can request the UCEN computer system 300 to provide more information about the matching suspect and the other reporting entities, which have reported the suspect before (block 2007). A joint investigation can be established among Reporting Financial Institution A 100 and other reporting entities.

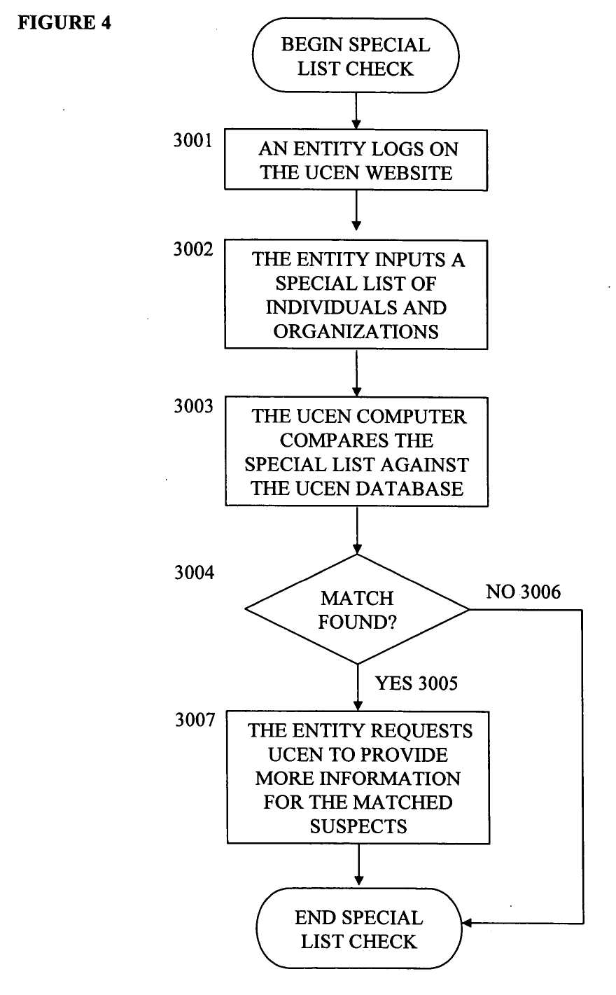

Similarly, references should also be made to the flowchart of FIG. 4 in combination with the system diagram of FIG. 1, which together illustrate how Reporting Financial Institution A 100 inputs a list and specially requests the UCEN computer system 300 to check whether any individual or organization (e.g., a new customer) on the list is also a suspect in the UCEN database.

First (block 3001), Reporting Financial Institution A 100 logs into the UCEN computer system 300 via network 400.

Then (block 3002), Reporting Financial Institution A 100 inputs a list of individuals and organizations into the UCEN computer.

After receiving the list (block 3003), the UCEN computer system 300 compares this list against the UCEN database.

The UCEN computer will determine whether there is any match between the list and its database (decision block 3004).

If there is no match (“NO” branch 3006 from the decision block 3004), the special check is complete.

If there is a match (“YES” branch 3005 from the decision block 3004), Reporting Financial Institution A 100 can request the UCEN computer system 300 to provide more information about the matching suspect and the other reporting entities, which have reported the suspect before (block 3007). A joint investigation can be established among Reporting Financial Institution A 100 and other reporting entities.

The embodiments described in this document can be assembled to form a variety of applications based on the need and the permissibility by law. Workers skilled in the art and technology to which this invention pertains will appreciate that alterations and changes in the described structure may be practiced without meaningfully departing from the principal, spirit and scope of this invention. Such alterations and changes should not be construed as deviations from the present invention.

1. A computerized method for facilitating the coordination among multiple financial institutions and other entities through networks to detect, monitor, and investigate suspects involved in suspicious financial activities, comprising:
connecting the entities to a shared computer system;
providing each financial institution and each other entity with means for communicating to the shared computing system case information about suspects and suspicious financial activities detected by that institution or that entity for the purpose of joint investigation;
storing the provided case information in a database maintained by the shared computer system;
comparing case information with case information provided by different entities to identify multiple instances of suspicious activity involving a common suspect but reported by multiple reporting entities; and
if such a common suspect is identified, informing each involved reporting entity of at least certain reported case information involving that common suspect, and contact information for the other said involved reporting entities whereby all said involved entities may contact one another to jointly investigate the common suspect and any involved suspicious activities.

2. The method of claim 1 wherein:
authorized personnel of a government agency log into the shared computer system, and manually enter case information concerning suspects and suspicious activities.

3. The method of claim 1 wherein:
authorized personnel of a government agency manually upload into the shared computer system electronic files containing case information concerning suspects and suspicious activities.

4. The method of claim 1 wherein:
a government computer system is connected to the shared computer system; and
the government computer system directly uploads into the shared computer system government data relating to the case information of the suspects and suspicious activities.

5. The method of claim 1 wherein:
authorized personnel of a financial institution log into the shared computer system, and manually enter the case information concerning suspects and suspicious activities.

6. The method of claim 1 wherein:
authorized personnel of a financial institution manually upload into the shared computer system electronic files of the case information of suspects and suspicious activities.

7. The method of claim 6, wherein:
the electronic files also include an electronic version of Suspicious Activity Reports, which financial institutions are providing to a government agency in compliance with a Bank Secrecy Act.

8. The method of claim 1 wherein:
a private computer system, which a financial institution uses to monitor, detect, investigate or report suspicious financial activities, directly uploads into the shared computer system electronic data concerning the case information of the suspects and suspicious activities.

9. The method of claim 8 wherein:
the electronic data also includes an electronic version of Suspicious Activity Reports, which financial institutions are providing to a government agency in compliance with a Bank Secrecy Act.

10. The method of claim 1 wherein:
authorized personnel of a merchant not subject to the reporting requirements of a Bank Secrecy Act logs into the shared computer system, and manually enters case information about fraud and other suspicious activities and any involved suspects.

11. The method of claim 1 wherein:
authorized personnel of a merchant not subject to the reporting requirements of a Bank Secrecy Act uploads into the shared computer system electronic files to report case information relating to fraud and other suspicious activities.

12. The method of claim 11 wherein:
the electronic files are automatically generated by an anti-fraud system of a merchant and are automatically uploaded into the shared computer system.

13. The method of claim 1 wherein the case information includes at least the category of the suspicious activity.

14. The method of claim 1 wherein the case information includes at least the dollar amount involved with the suspicious activity.

15. The method of claim 1 wherein the case information includes at least the transaction types of the suspicious activities.

16. The method of claim 1 wherein the case information includes at least the location of the suspicious activities.

17. The method of claim 1 wherein the case information includes at least the time frame of the suspicious activities.

18. The method of claim 1 wherein the case information includes at least the identity of the reporting entity.

19. The method of claim 1 wherein the case information includes at least the contact information of the reporting entity.

20. The method of claim 1 wherein the contact information includes the name of a security officer.

21. The method of claim 1 further comprising:
using the shared computer system to compile a list of suspects based on the criteria defined by an authorized user of a financial institution or other entity;
comparing the suspects on the compiled list with external identity information maintained in a private database of a financial institution or other entity, not accessible to the shared computer system, to identify potential matches;
after a potential match is found, requesting the shared computer system to provide related case information concerning that potentially matched suspects and the contact information of the involved reporting entities so that all involved entities may contact one another to jointly investigate the common suspects and any involved suspicious activities.

22. The method of claim 21 wherein a government agency uses a government computer system to compare the list with a government list maintained by the government computer system and to request from the shared computer all case description and contact information involving any potential match found by the government computer system.

23. The method of claim 21 wherein the comparing and requesting steps are manually implemented.

24. The method of claim 21 wherein at least the comparing step is implemented by a private computer system not connected to the shared computer system.

25. The method of claim 1 further comprising:
inputting a specific list of individuals and/or organizations from a requesting financial institution or other entity;
determining whether any individual or organization on that list has any record of suspicious activities in the database of the shared computer; and
if there is any record in the database concerning any individual or organization on the specific list, providing the requesting financial institution or other entity with case information about any reported suspicious activities involving that individual or organization on the specific list and the contact information of the involved reporting entities so that all involved entities may contact one another to jointly investigate the common suspect and any involved suspicious activities.

26. The method of claim 1 further comprising:
determining whether a newly reported case is a confirmed crime; and
if it is a confirmed crime, informing all qualified and participating entities of the confirmed crime, the identity of the suspect, and the case information so that these entities can implement a preventive procedure to protect themselves.

27. The method of claim 1 further comprising:
permitting a financial institution or other entity to log into the shared computer system and enter the identity of a new customer;
determining whether the identity of the new customer matches the identity of any suspect in the database of the shared computer; and
if there is a match, informing the said financial institution or the said entity of the match so that a proper action can be taken to protect the said financial institution or the said entity.

28. The method of claim 1 further comprising:
permitting a financial institution or other entity to log into the shared computer system and enter the identity of an individual or an organization that is in the process of conducting transactions with the said financial institution or the said entity;
determining whether the identity of the individual or the organization matches the identity of any suspect in the database of the shared computer; and
if there is a match, informing the said financial institution or the said entity of the match so that a proper action can be taken to protect the said financial institution or the said entity.

29. The method of claim 1 further comprising:
inputting a specific list of persons from a requesting entity;
determining whether any person on that list has any records of suspicious activities in the database of the shared computer; and
providing the requesting entity with information about any reported suspicious activities involving any of those specific individuals.

30. The method of claim 1 wherein the providing and informing steps are in accordance with the Bank Secrecy Act and the permission by Section 314 (a) and Section 314 (b) of the USA PATRIOT Act;

31. A computerized method for facilitating the coordination among multiple financial institutions and other networked entities to detect, monitor, and investigate suspects involved in suspicious financial activities, comprising:
connecting the entities to a shared computer system;
providing each financial institution and each other entity with means for communicating to the shared computing system case information about suspects and suspicious financial activities detected by that institution or that entity for the purpose of joint investigation;
storing the provided case information in a database maintained by the shared computer system;
comparing case information with case information provided by different entities to identify multiple instances of suspicious activity involving a common suspect but reported by multiple reporting entities;
if such a common suspect is identified, informing each involved reporting entity of all reported case information involving that common suspect, and providing contact information for the other said involved reporting entities, whereby all said involved entities may contact one another to jointly investigate the common suspect and any involved suspicious activities;
using the shared computer system to compile a list of suspects based on the criteria defined by an authorized user of a financial institution or other entity and comparing the suspects on the compiled list with external identity information maintained in a private database of a financial institution or other entity, not accessible to the shared computer system, to identify potential matches, and after a potential match is found, requesting the shared computer system to provide related case information concerning that potentially matched suspects and the contact information of the involved reporting entities;
inputting a specific list of individuals and/or organizations from a requesting financial institution or other entity and determining whether any individual or organization on that list has any record of suspicious activities in the database of the shared computer; and if there is any record in the database concerning any individual or organization on the specific list, providing the requesting financial institution or other entity with case information about any reported suspicious activities involving that individual or organization on the specific list and the contact information of the involved reporting entities;
determining whether a newly reported case is a confirmed crime, and if it is a confirmed crime, informing all qualified and participating entities of the confirmed crime, the identity of the suspect, and the case information so that these entities can implement a preventive procedure to protect themselves;
permitting a financial institution or other entity to log into the shared computer system and enter the identity of a new customer, determining whether the identity of the new customer matches the identity of any suspect in the database of the shared computer, and if there is a match, informing the said financial institution or the said entity of the match so that a proper action can be taken to protect the said financial institution or the said entity; and
permitting a financial institution or other entity to log into the shared computer system and enter the identity of an individual or an organization that is in the process of conducting transactions with the said financial institution or the said entity, determining whether the identity of the individual or the organization matches the identity of any suspect in the database of the shared computer, and if there is a match, informing the said financial institution or the said entity of the match so that a proper action can be taken to protect the said financial institution or the said entity;
wherein:
the case information includes information concerning the category of the suspicious activity, the dollar amount involved, the transaction type, the location, and the time frame;
a government agency causes certain case information concerning suspects and suspicious activities to be loaded into the shared computer system;
a plurality of financial institutions each causes certain case information concerning suspects and suspicious activities to be loaded into the shared computer system;
the shared database also includes an electronic version of Suspicious Activity Reports which financial institutions are providing to a government agency in compliance with a Bank Secrecy Act;
a plurality of merchants not subject to the reporting requirements of a Bank Secrecy Act each causes certain case information about fraud and other suspicious activities and any involved suspects to be loaded into the shared computer system; and
a government agency uses a government computer system to compare a list compiled by the shared computer system with a government list maintained by the government computer system and requests from the shared computer all case description and contact information involving any potential match found by the government computer system.

32. The method of claim 31 wherein any information provided by a financial institution is handled in accordance with the Bank Secrecy Act and the permission by Section 314 (a) and Section 314 (b) of the USA PATRIOT Act;
